(19) United States
(12) Patent Application Publication
(10) Pub. No.: US 2012/0013645 A1
(43) Pub. Date: Jan. 19, 2012

(54) DISPLAY AND METHOD OF DISPLAYING ICON IMAGE

(76) Inventor: Chen-Yang Hu, Taoyuan County (TW)

(21) Appl. No.: 13/159,423

(22) Filed: Jun. 14, 2011

(30) Foreign Application Priority Data
Jul. 19, 2010 (CN) 201010238007.9

(51) Int. Cl. G09G 5/00

(52) U.S. Cl. 345/667

(57) ABSTRACT

A display system and a method of displaying icon image for the display system are disclosed. The method is to display an icon image on a background image on a screen of the display system, to sense a distance between an object and the icon image, and to adjust the size of the icon image on the screen and display the adjusted icon image on the background image, when the distance is shorter than a predetermined value. Byway of adjusting the size of the icon image, the invention can re-display the icon image in a proper size for a user to conveniently point the adjusted icon image, so as to reduce the probability of operation failure, especially for operation on tiny icon images relative to a finger.

### BACKGROUND OF THE INVENTION

1. Field of the Invention

The invention relates to a display system and a method of displaying icon image, and especially relates to a display system and a method of displaying an enlarged/shrinkage icon image when a distance between the icon image and an object is shorter than a predetermined value.

2. Description of the Prior Art

Touch screens have been applied widely to various information products and have substituted for conventional input devices. In general, the touch screen of an information product has a touch area corresponding to a displaying area where a function icon is displayed. The function icon is manipulated by touching the touch area; that is, a user can perform various touch operations on the touch screen by use of his finger or a touch pen so as to control the information product to execute corresponding functions.

Current information products, especially consumer electronic products are designed toward small and thin, so the touch screen thereof is usually small. The touch area for touch operation is therefore too small to perform touch operation on function icons conveniently. In addition, there are usually a lot of independent icons displayed on the displaying area, so the area occupied by each icon is limited, which makes the user mis-touch adjacent icons easily. It also reduces the convenience of operating on the touch screen.

### SUMMARY OF THE INVENTION

An objective of the invention is to provide a display, which can adjust and display an icon image in a proper size for a user to point easily, so as to reduce the probability of operation failure.

The display system of the invention includes a displaying module, a sensing module, and a processing module electrically connected to the displaying module and the sensing module. The displaying module includes a screen and displays an icon image on a background image on the screen. The sensing module is used for sensing a distance between an object and the icon image. The processing module controls the displaying module to adjust the size of the icon image and display the adjusted icon image on the background image on the screen when the distance is shorter than a predetermined value.

Another objective of the invention is to provide a method of displaying icon image for a display system of the invention. The method is to adjust and display an icon image in a proper size for a user to point easily, so as to reduce the probability of operation failure.

The method of the invention includes the following steps of: displaying a icon image on a background image on a screen of the display; sensing a distance between an object and the icon image; and adjusting the size of the icon image on the screen and displaying the adjusted icon image on the background image, when the distance is shorter than a predetermined value. Notably, in a preferable embodiment of the present invention, when the size of the icon image displayed on the screen is adjusted, part or all of the background image is remained the original (or default) size.

In sum, the size of the icon image can be adjusted when the distance between the icon image and the object is shorter than a predetermined value and the adjusted icon image can be displayed on the screen with a proper size, especially in a bigger size, so that a user can point the adjusted icon image with ease, reducing the probability of operation failure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram showing a preferred embodiment of a display system according to the present invention.

FIG. 2 and FIG. 3 are schematic diagrams illustrating different stages of a pointing action on the screen in FIG. 1.

FIG. 4 and FIG. 5 are schematic diagrams illustrating different stages of another pointing action that the object slides on the screen in FIG. 1.

FIG. 6 is a schematic diagram illustrating another pointing action on the screen in FIG. 1 according to another embodiment.

FIG. 7 is a flowchart of the method of displaying icon image according to the invention.

### DETAILED DESCRIPTION

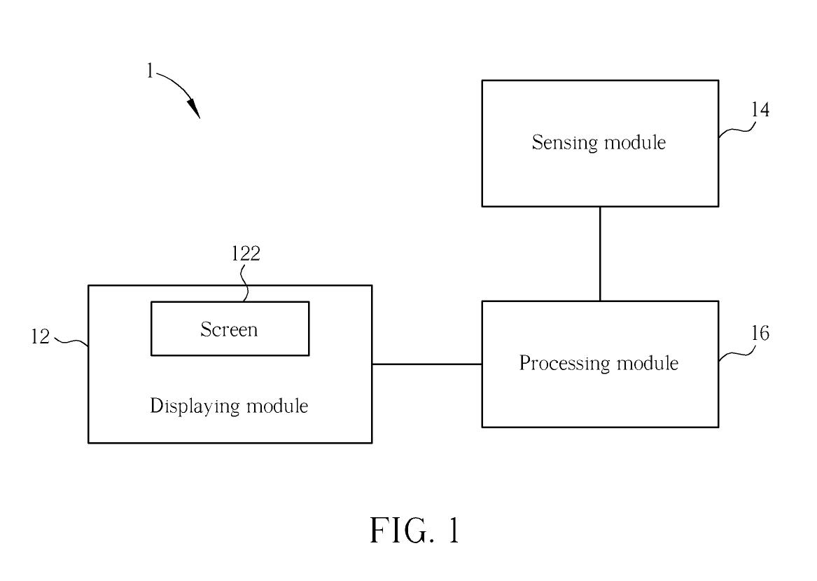

Please refer to FIG. 1, which is a function block diagram of a preferred embodiment of a display system according to the present invention. The display system 1 includes a displaying module 12, a sensing module 14, and a processing module 16. The processing module 16 is electrically connected to the displaying module 12 and the sensing module 14. The displaying module 12 includes a screen 122. In practice, the invention can be applied to a tablet PC, a notebook, an all-in-one PC, a PDA, a mobile phone, a digital camera, and so on, but not limited to these.

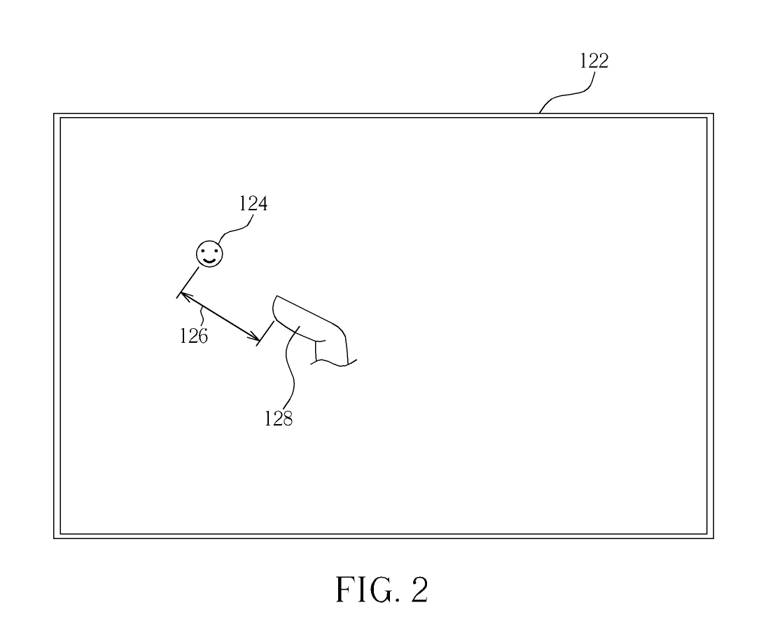

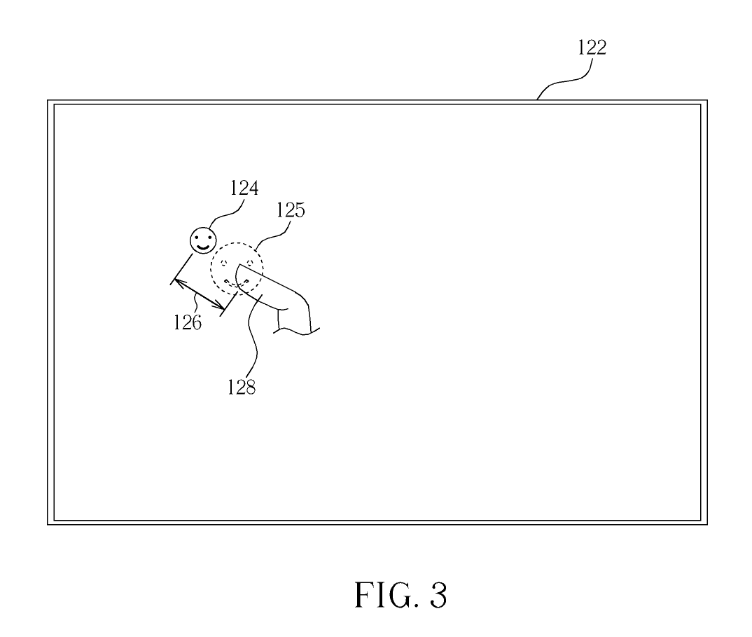

Please also refer to FIG. 2 and FIG. 3, which are schematic diagrams illustrating different stages of a pointing action on the screen 122. The displaying module 12 displays an icon image 124 on a background image on the screen 122. For better illustrating the following description, the background image is not shown in the figures; notably, in a preferred embodiment of the present invention, part or all of the background image is maintained its original (or default size), when the icon image 124 is adjusted. The sensing module 14 senses a distance 126 between an object 128 and the icon image 124. As shown in FIG. 2, the object is a finger of a user (or a touch pen in another case) and is approaching the icon image 124. When the distance 126 is shorter than a predetermined value, the processing module 16 controls the displaying module 12 to adjust the size of the icon image 124 and display the adjusted icon image 125 (shown in dashed lines) on the background image on the screen 122. In one preferred embodiment, when the distance is shorter than a predetermined value, the icon image 125 is enlarged, such that the user can point the enlarged icon image 125 with ease, reducing the probability of operation failure. Note that the adjusted icon image is not limited to being zoomed in or enlarged, it can be zoomed out or made smaller as well in accordance with each application condition. In another preferred embodiment, the adjusted icon image can be displayed at a new position close to the object 128, or substantially under the object 128 to provide a better operation interface for the user.

In yet another preferred embodiment of the present invention, when the object 128 is moving further from the icon image 124, and the sensing module 14 senses that the distance 126 is longer than the predetermined value, the processing module 16 controls the displaying module 12 to reset the enlarged icon image 125 to a default size, preferably the original size of the icon image 125. It is noticeable that, the above resetting can be realized by only removing the enlarged icon image 125 if the original icon image 124 is still completely displayed on the screen 122, or by removing the enlarged icon image 125 and re-displaying the original icon image 124 on the screen 122 if the original icon image 124 is covered totally or partially by the enlarge image 125. The practical details for the above resetting can be based on current software techniques.

In yet another preferred embodiment, the sensing module 14 comprises a plurality of proximity sensors for sensing the distance 126, but the invention is not limited to this. In practice, the sensing module 14 can be realized by a position sensing module of a touch panel, so the sensing module 14 may include different sensors depending on different position sensing systems. The predetermined value for the distance 126 is set according to each application condition, e.g. 5 mm in a mobile phone or 10 mm in a tablet PC. In still yet another preferred embodiment, the icon image 124 comprises a function icon provided for inputting an instruction. For example, the user can point the icon image 124 to trigger a new window displayed on the screen 122 for more interaction with the display 1.

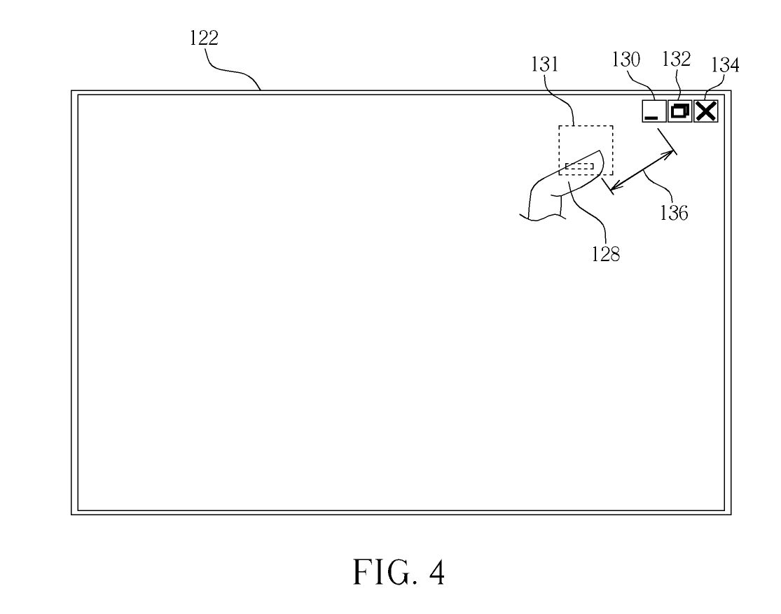

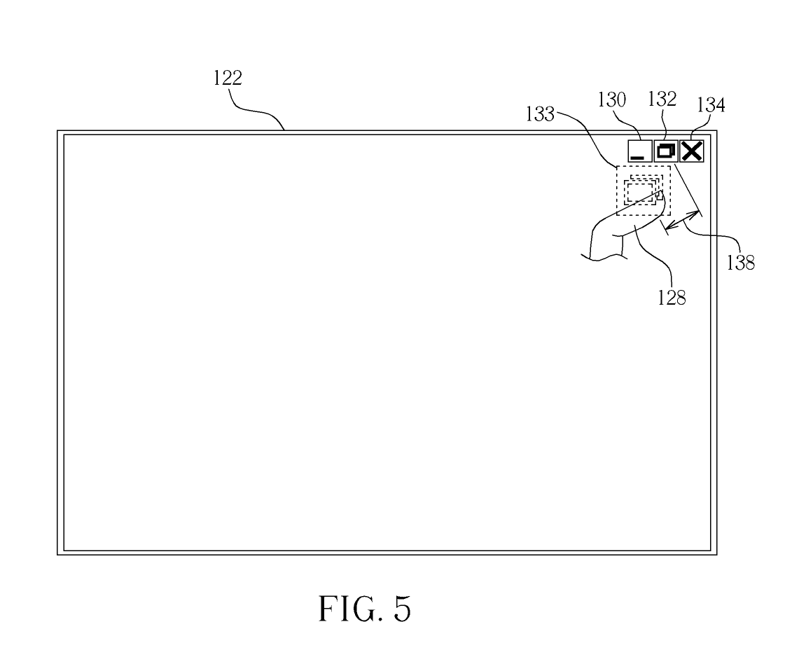

The above embodiments are explained with only one icon image, but the invention is not limited to it. Please refer to FIG. 4 and FIG. 5, which are schematic diagrams illustrating different stages of another pointing action of the object moving along three icon images 130, 132 and 134 on the screen 122. In this embodiment, the displaying module 12 displays three icon images 130, 132 and 134 adjacent in a row on a background image on the screen 122. As shown in FIG. 4, the object 128 is approaching these icon images 130, 132 and 134 from the left side of the icon images 130, 132 and 134, that is, the object 128 first approaches the icon image 130, and next the icon image 132, and then the icon image 134 in sequence. When the distance 136 between the object 128 and the icon image 130 is shorter than the predetermined value, the processing module 16 controls the displaying module 12 to adjust the size of the icon image 130 and display the adjusted icon image 131 (shown in dashed lines) on the background image on the screen 122. As shown in FIG. 5, when the object 128 is moved closer to the icon image 132 than to the icon image 130, the processing module 16 controls the displaying module 12 to reset the adjusted icon image 130 to a default size (even the distance between the object 128 and the icon image 130 is shorter than the predetermined value), and adjust the size of the icon image 132 and display the adjusted icon image 133 (shown in dashed lines) on the background image on the screen 122.

Similarly, when the object 128 is moved closer to the icon image 134 than to the icon image 132, the processing module 16 controls the displaying module 12 to reset the adjusted icon image 132 to a default size and adjust the size of the icon image 134 on the screen 122.

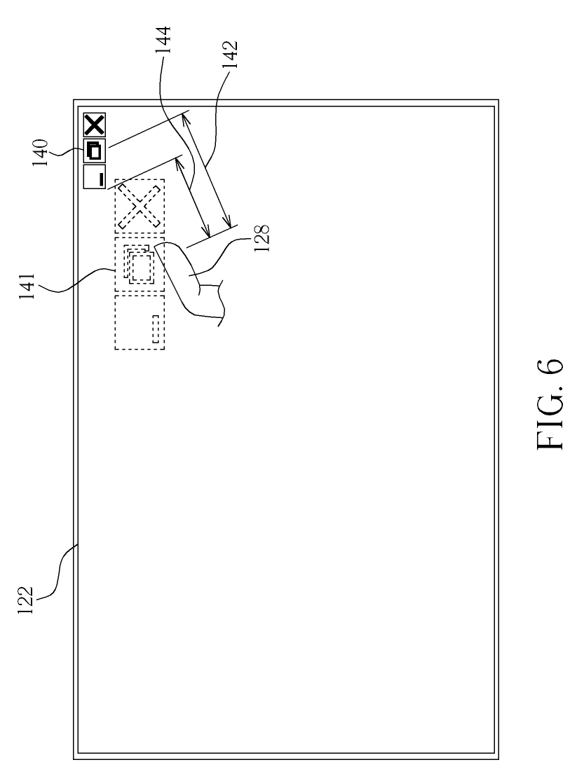

In the foregoing embodiments, each of the icon images 124, 130, 132, and 134 comprises at least one function icons. As an example shown in FIG. 6, the displaying module 12 displays an icon image 140 including three function icons on a background image on the screen 122. As shown in FIG. 6, the object 128 is approaching the icon image 140 from the left side of the icon image 140. When the distance 142 between the object 128 and the icon image 140 is shorter than the predetermined value, the processing module 16 controls the displaying module 12 to adjust the size of the icon image 140 and display the adjusted icon image 141 (shown in dashed lines) on the background image on the screen 122. Therefore, the user can see three function icons at the same time and perform a pointing action on one of the function icons with ease.

It is added that, in the above embodiments, the distances 126, 136, 138 and 142 can be determined by the position of the object 128 to the centers of the icon images 124, 130, 132, 134 and 140 respectively; however, the invention is not limited to it. When the area of an icon image is sufficient to distinguish, the distance may be determined according to the position of the object 128 relative to the edge of the icon image. For example, the distance 144 is determined according to the position of the object 128 relative to the edge of the icon image 140 closet to the position of the object 128. In addition, in the above embodiments, the icon image 130, 132 and 134 are adjusted independently, but the invention is not limited to it. For example, for the convenience of the user, when the distance 136 is shorter than the predetermined value, the processing module 16 can control the displaying module 12 to adjust the size of the image icons 132 and 134 as well as the size of the image icon 130, the displaying result of which is similar to the illustration of FIG. 6 when the image icon 140 is regarded as three independent image icons.

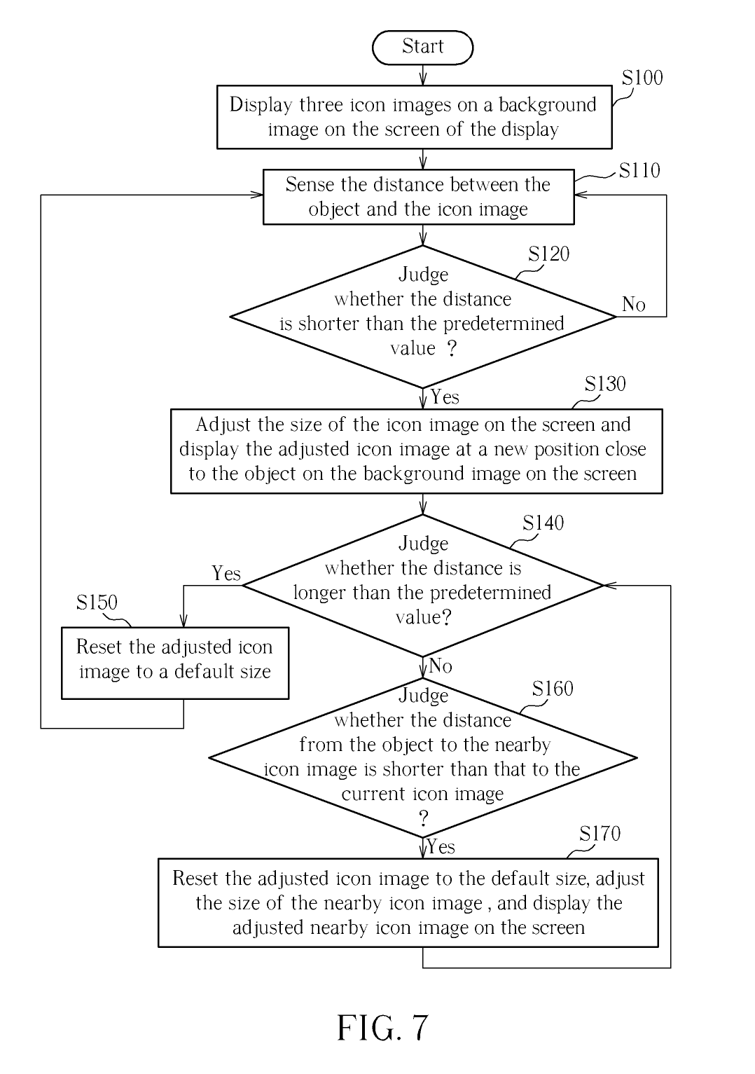

The above embodiments have also explained the method of displaying icon image of the invention substantially. The following is going to show the method of displaying icon image of the invention briefly in flowcharts. Please refer to FIG. 7 together with FIG. 4 and FIG. 5. FIG. 7 is a flowchart of the method of displaying icon image according to the invention. The method is to display three icon images 130, 132 and 134 on a background image on the screen 122 of the display 1, as shown in the step S100; and to sense the distance 136 between the object 128 and the icon image 130, as shown in the step S110. It is added that the icon images 130, 132 and 134 are displayed adjacently in a row so the icon image 130 which is closest to the object 128 will be considered first.

The method is to judge whether the distance 136 is shorter than the predetermined value, as shown in the step S120. If the judgment result is NO, the method is back to the step S110 to keep sensing the distance 136. If the judgment result is YES, the method is to adjust the size of the icon image 130 on the screen 122 and display the adjusted icon image 131 at a new position close to the object 128 on the background image on the screen 122, as shown in the step S130. For most cases, the adjusted icon image 131 is enlarged. But the invention is not limited to it. For example, if an icon image is only partially shown because the icon image is too large to be totally shown on the screen, it is necessary to shrink the icon image for obtaining a whole view of the icon image.

The method is to judge whether the distance 136 is longer than the predetermined value, as shown in the step S140. If the judgment result of the step S140 is YES, the method is to reset the adjusted icon image 131 to a default size, as shown in the step S150. If the judgment result of the step S140 is NO, the method is to judge whether the distance 138 from the object 128 to the nearby icon image 132 is shorter than the distance 136 from the object 128 to the current icon image 130, as shown in the step S160. If the judgment result of the step S160 is YES, the method is to reset the adjusted icon image 131 to the default size, adjust the size of the icon image 132, and display the adjusted icon image 133 on the screen 122, as shown in the step S170. An embodiment for the step S170 is that the object 128 is moved closer to the icon image 132 than to the original icon image 130. For other descriptions about displaying icon images, please refer to the descriptions of the above embodiments.

As discussed above, the display and the method can adjust the size of the icon image according to the distance between the icon image and the object and then display the adjusted icon image in a proper size, especially in a bigger size, so that a user can point the adjusted icon image with ease, reducing the probability of operation failure.

Those skilled in the art will readily observe that numerous modifications and alterations of the device and method may be made while retaining the teachings of the invention.

What is claimed is:

1. A display system, comprising:
a displaying module comprising a screen, the displaying module displaying a first icon image on a background image on the screen;
a sensing module for sensing a distance between an object and the first icon image; and
a processing module electrically connected to the displaying module and the sensing module, the processing module controlling the displaying module to adjust the size of the first icon image and display the adjusted first icon image on the background image on the screen when the distance is shorter than a predetermined value.

2. The display system of claim 1, wherein the first icon image comprises at least one function icon.

3. The display system of claim 2, wherein the function icon is provided for inputting an instruction.

4. The display system of claim 1, wherein when the size of the first icon image is adjusted, the adjusted first icon image is displayed at a new position close to the object.

5. The display system of claim 1, wherein the displaying module displays a second icon image adjacent to the first icon image on the screen, and the processing module controls the displaying module to adjust the size of the first icon image and the second icon image simultaneously when the distance is shorter than the predetermined value.

6. The display system of claim 1, wherein when the distance is shorter than the predetermined value, the processing module controls the displaying module to enlarge the first icon image.

7. The display system of claim 1, wherein when the sensing module senses that the distance is longer than the predetermined value, the processing module controls the displaying module to reset the adjusted first icon image to a default size.

8. The display system of claim 1, wherein the sensing module comprises a plurality of proximity sensors for sensing the distance.

9. The display system of claim 1, wherein the displaying module displays a second icon image adjacent to the first icon image on the screen, and when the first icon image is adjusted, the processing module controls the displaying module to reset the adjusted first icon image to a default size and adjust the size of the second icon image on the screen when the object is moved closer to the second icon image than to the original first icon image.

10. A method of displaying icon image for a display system, the method comprising the steps of:
(a) displaying a first icon image on a background image on a screen of the display system;
(b) sensing a distance between an object and the first icon image; and
(c) adjusting the size of the first icon image on the screen, and displaying the adjusted first icon image on the background image, when the distance is shorter than a predetermined value.

11. The method of claim 10, wherein the first icon image comprises at least one function icon, and the function icon is provided for inputting an instruction.

12. The method of claim 10, wherein in the step (c), when the size of the first icon image is adjusted, the adjusted first icon image is displayed at a new position close to the object.

13. The method of claim 10, wherein the step (a) further comprises displaying a second icon image adjacent to the first icon image on the screen, and the step (c) further comprises adjusting the size of the first icon image and the second icon image simultaneously when the distance is shorter than the predetermined value.

14. The method of claim 10, wherein the step of adjusting the size of the first icon image comprises enlarging the first icon image.

15. The method of claim 10, further comprising the step of:
(d) when the distance is longer than the predetermined value, resetting the adjusted first icon image to a default size.

16. The method of claim 10, wherein the step (b) further comprises providing a plurality of proximity sensors for sensing the distance.

17. The method of claim 10, wherein the step (a) further comprises displaying a second icon image adjacent to the first icon image on the screen, and the method further comprises the step of:
(e) when the first icon image is adjusted, resetting the first icon image to a default size and adjusting the size of the second icon image on the screen when the object is moved closer to the second icon image than to the original first icon image.
